(19) United States
(12) Patent Application Publication
(10) Pub. No.: US 2007/0258151 A1
(43) Pub. Date: Nov. 8, 2007

(54) Method of Making a High-Quality Optical System for the Cost of a Low-Quality Optical System

(76) Inventors: Evgeny Frumker, Beer-Sheva (IL); Dov Nir, Kfar Vradim (IL)

Correspondence Address: Mark M. Friedman;c/o Polkinghorn, 9003 Florin Way, Upper Marlboro, MD, 20772, US

(21) Appl. No.: 10/571,905

(22) PCT Filed: Sep. 9, 2004
(86) PCT No.: PCT/IL04/00829

§ 371 Date: May 3, 2007

(30) Foreign Application Priority Data
Sep. 14, 2003 (IL) 157920

(51) Int. Cl. G02B 13/18

(52) U.S. Cl. 359/708

(57) ABSTRACT

A method of making an optical system, including the steps of fabricating an optical subsystem of the optical system to within a first precision, measuring an aberration of the optical subsystem to within a second precision that is more precise than the first precision, and fabricating a static optical element that corrects the aberration to within the second precision.

### FIELD OF THE INVENTION

The present invention relates to the manufacture of optical systems and, more particularly, to a method for manufacturing a high-quality optical system for little more than the cost of a low-quality optical system.

### BACKGROUND OF THE INVENTION

### Hubble Space Telescope

The Hubble Space Telescope (HST) was launched into low Earth orbit in 1990 for the purpose of performing astronomical observations beyond the turbulence of the Earth's atmosphere. The main mirror of the HST was fabricated to within a precision of less than one-tenth of a wavelength of visible light, with the expectation that the images acquired by the HST would have a resolution near or at the mirror's diffraction limit.

It soon was discovered that the HST's main mirror had been fabricated very precisely to within less than one-tenth of a wavelength of visible light relative to the wrong shape. Therefore, corrective optics were fabricated, and installed in 1993, to correct the HST's optics.

### Adaptive Optics

Another approach to overcoming the influence of atmospheric turbulence on astronomical observations is to use adaptive optics to measure and compensate for the effect of the turbulence in real time. How this is done is illustrated schematically in FIG. 1.

FIG. 1 shows a telescope 10 that is aimed at both an astronomical object of interest and a reference star. The reference star could be either a bright star that has a small angular separation from the astronomical object or an artificial laser guide star. Light 12 emerging from the exit pupil of telescope 10 is reflected by a deformable mirror 32 to a beamsplitter 24. A portion 16 of reflected light 14 passes through beamsplitter 24 to be imaged by a camera 26. Another portion 18 of reflected light 14 is reflected by beamsplitter 24 to a wavefront sensor 28 that senses the relative phases of light 18 impinging thereon. These relative phase measurements are sent to a control system 30. Control system 30 uses a set of actuators 34 to change the shape of mirror 32 in a way that minimizes the differences in the phase of light 18 across the sensing surface of wavefront sensor 28. As a result, wavefronts 20 of light from the reference star that are distorted by atmospheric turbulence are changed to flat, parallel reflected wavefronts. Just as the light from the reference star then is imaged by camera 26 at the diffraction limit of telescope 10, so the light from the astronomical object is imaged by camera 26 at the diffraction limit of telescope 10.

Iwasaki et al., in US Patent Application No. 2001/0028028 A1, teach a similar method for correcting aberration in an optical system that is used for reading optical disks. FIG. 2 illustrates, schematically, an optical system 40 of Iwasaki et al. as used to read an optical disk 38. Coherent light 58 from a laser 42 is converted to a collimated beam of light by a lens 44. The collimated beam passes through a beamsplitter 50 and an aberration correction optical unit 52, and is focused by a lens 46 onto optical disk 38. Light reflected by optical disk 38 is collimated by lens 46 and passes back to beamsplitter 50 via aberration correction optical unit 52. Beamsplitter 50 reflects a portion of the light from optical disk 38 to a lens 48 that focuses this light onto a photodetector 54. A control circuit 56 applies a voltage V to aberration correction optical unit 52 in a manner that causes aberration correction optical unit 52 to compensate for spherical aberration in lenses 44, 46 and 48 and for coma aberration due to inclination of optical disk 38.

Aberration correction optical unit 52 is a liquid crystal element sandwiched between two transparent electrodes. The alignment state of the liquid crystal element changes in response to the electric field between the electrodes that is induced by the applied voltage V. The shapes of the electrodes are selected according to the type of aberration (spherical or coma) to be corrected. The degree of correction is determined by the magnitude of the applied voltage V.

### SUMMARY OF THE INVENTION

According to the present invention there is provided a method of making an optical system, including the steps of: (a) fabricating an optical subsystem of the optical system to within a first precision; (b) measuring an aberration of the optical subsystem to within a second precision that is more precise than the first precision; and (c) fabricating a static optical element that corrects the aberration to within the second precision.

According to the present invention there is provided an optical system including: (a) an optical subsystem fabricated to within a first precision; and (b) a static optical element, fabricated to within a second precision that is more precise than the first precision, for correcting an aberration of the optical subsystem.

According to the present invention there is provided a device for making an optical element, including: (a) a source for emitting a light wave that is a plane wave; (b) a spatial light modulator for modulating the plane wave in accordance with a predetermined profile, thereby transforming the plane wave into a modulated light wave; and (c) a projection system for projecting the modulated light wave onto a photosensitive workpiece, as one step in transforming the workpiece into the optical element.

According to the present invention there is provided a method of making an optical element that is configured with a predetermined profile, including the steps of: (a) modulating a light wave that is a plane wave in accordance with the profile, thereby transforming the plane wave into a modulated light wave; and (b) projecting the modulated light wave onto a photosensitive medium so as to prepare the photosensitive medium for transformation to the optical element.

According to the present invention there is provided a production line for making a plurality of optical systems for manipulating light to within a desired precision, including: (a) a first station for fabricating, for each optical system, a respective optical subsystem to within a preliminary precision that is less precise than the desired precision; (b) a second station for measuring a respective aberration of each optical subsystem to within the desired precision; and (c) a third station for fabricating, for each optical system, a respective static optical element that corrects the respective aberration to within the desired precision.

The present invention is a method for making a high-precision optical system at a cost that is little more than the cost of a comparable low-precision optical system. The cost of fabricating an optical component to high precision (one-tenth of a wavelength or better), as were the HST main mirror and the HST corrective optics, typically is one to two orders of magnitude greater than the cost of fabricating such an optical component to lower precision (e.g. one-half of a wavelength). For example, reflector telescope optics fabricated to a precision of one-tenth of a wavelength typically cost about $50,000. Comparable optics fabricated to a precision of one-half of a wavelength would cost about $2000. According to the present invention, an optical component that is a subsystem of a larger optical system is fabricated to relatively low precision. Then, the aberration of the optical component is measured to high precision, and a static optical element is fabricated to compensate for the measured aberration. Finally, the static optical element is fixed in place relative to the optical component so as to correct the aberration. The combination of the low-precision optical component and the static optical element has an optical performance comparable to the optical performance of a high-precision optical component, at a cost that is higher than the cost of the low-precision optical component alone but is only a fraction of the cost of the high-precision optical component.

The difference between the present invention and the HST is that in the case of the HST, both the main mirror and the corrective optics were fabricated to high precision, whereas according to the present invention, only the corrective optics, and not the optical subsystem whose aberration is being corrected, is fabricated to high precision. The difference between the present invention and the teachings of Iwasaki et al. is that the corrective optical element of the present invention is a static element, meaning that the optical properties of the element are fixed in advance and not changed during use, whereas aberration correction optical unit 52 of Iwasaki et al. is dynamic, in the sense that the degree of correction is changed during use by changing the applied voltage V.

Preferably, the measuring of the aberration of the optical subsystem is effected using interferometry. Alternatively, the measuring of the aberration of the optical subsystem is effected using a Shack-Hartman wavefront sensor.

Most preferably, the measuring of the aberration of the optical subsystem is effected as follows: A light wave that is initially a plane wave is passed through the optical subsystem and then is reflected by a deformable mirror that includes a plurality of actuators, each of which actuators positions a respective portion of the surface of the mirror. As is generally understood in the art, a “plane wave” is a coherent monochromatic light wave whose surfaces of constant phase are substantially flat and parallel. A property of the reflected light that is related to the aberration is measured, and the actuators are adjusted until the deformable mirror corrects the aberration to within the desired high precision to which the overall optical system is to be corrected. The static corrective optical element then is fabricated according to the final adjusted positions of the actuators.

Preferably, the property of the reflected light that is measured is the wavefront shape of the reflected light, and the actuators are adjusted until the measured wavefront shape is planar to within the desired high precision to which the overall optical system is to be corrected. Note that this preferred method of measuring the aberration differs from the use of a Shack-Hartman wavefront sensor to measure the aberration in that a Shack-Hartman wavefront sensor measures wavefront shape explicitly, whereas this preferred method of measuring the aberration measures wavefront shape only implicitly: the wavefront shape is sufficiently planar when the aberration is corrected to within the desired high precision.

Preferably, the adjustment of the actuators is effected using a nonlinear optimization algorithm, for example a simulated annealing algorithm or a genetic algorithm.

Optionally, the light that is reflected from the deformable mirror is passed again through the optical subsystem before its wavefront shape is measured. Preferably, the measuring of the wavefront shape is effected using a wavefront sensor.

Preferably, the static corrective optical element is fabricated by steps including configuring the shape of the static corrective optical element to correct the aberration of the optical subsystem. This shaping of the static corrective optical element is performed, for example, by photolithography or by laser ablation. Alternatively, the static corrective optical element is fabricated by steps including configuring the refractive index of the static corrective optical element to correct the aberration of the optical subsystem.

Preferably, the static corrective optical element is a transmissive optical element. Alternatively, the static corrective optical element is a reflective optical element.

The scope of the present invention also includes a device and method for making an optical element, such as the static optical element, in accordance with a predetermined profile.

The device for making the optical element includes a source that emits a light wave that is a plane wave, a spatial light modulator for modulating the plane wave in accordance with the profile, and a projection system for projecting the modulated light wave onto a photosensitive workpiece. Preferably, the spatial light modulator is a liquid crystal spatial light modulator. Preferably, the projection system includes a first lens, a second lens, and an aperture, between the two lenses, for allowing only the first order diffraction pattern of the modulated light wave from the first lens to reach the second lens. Most preferably, the lenses are Fourier transform lenses. Preferably, the photosensitive workpiece includes photoresist.

The method of making the optical element includes the steps of modulating a light wave that starts out as a plane wave in accordance with the profile, projecting the modulated light wave onto the workpiece, and developing the workpiece for an amount of time sufficient to configure the workpiece with the desired profile.

The scope of the present invention also includes a production line for making a plurality of optical systems using the method of the present invention. The production line includes four stations. At the first station, an optical subsystem of each system is fabricated to low precision. At the second station, the aberration of each optical subsystem is measured to high precision. At the third station, static optical elements are fabricated for correcting the aberrations to high precision. At the fourth station, each static optical element is mated to its respective optical subsystem and fixed in place so that the combination of the optical subsystem and the static optical element constitute a high-precision optical system, with the aberration of the optical subsystem being corrected to high precision by the static optical element.

### BRIEF DESCRIPTION OF THE DRAWINGS

The invention is herein described, by way of example only, with reference to the accompanying drawings, wherein:

FIG. 1 (prior art) illustrates the use of adaptive optics in astronomy;

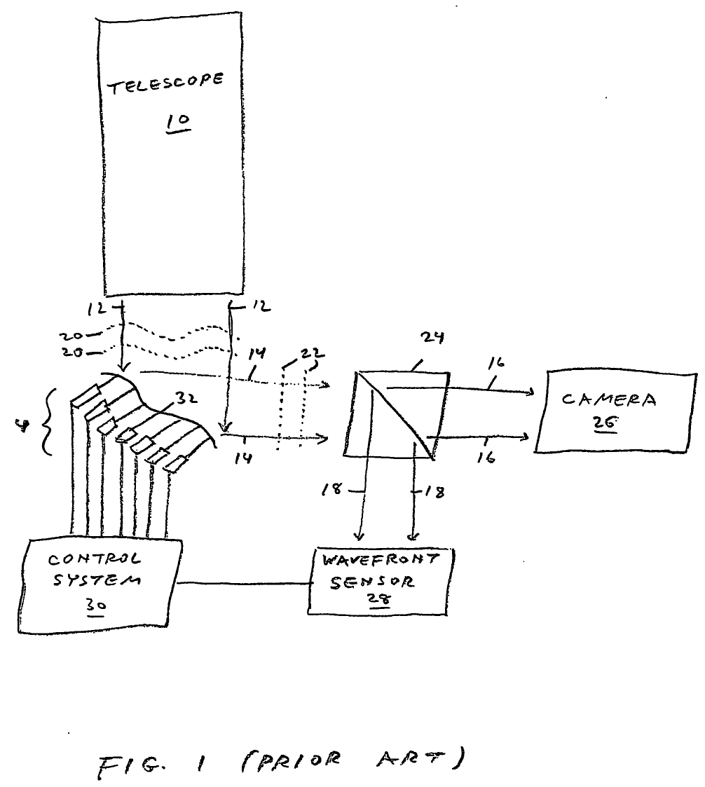

FIG. 2 (prior art) illustrates an optical system for reading an optical disk while correcting for aberration;

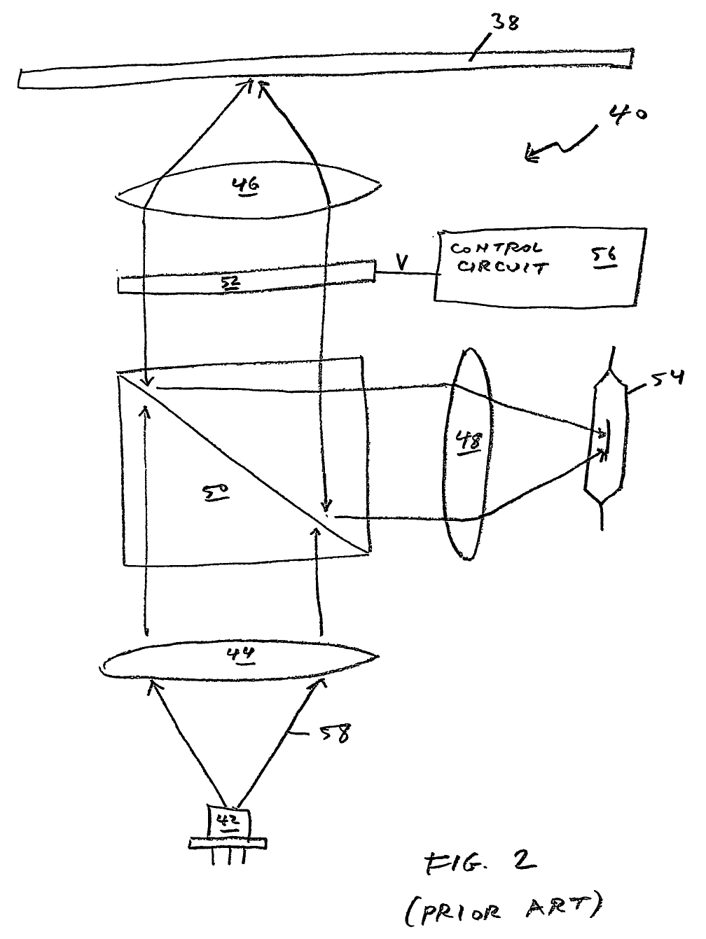

FIG. 3 is a schematic illustration of an optical system of the present invention;

FIG. 4 illustrates a method of measuring phase deviation;

FIG. 5 is a schematic illustration of a photolithographic projective device for making transmissive static corrective optical elements;

FIG. 6 is a schematic illustration of a source of plane waves;

FIG. 7 is a schematic illustration of a production line of the present invention.

### DESCRIPTION OF THE PREFERRED EMBODIMENTS

The present invention is of a method of manufacturing optical systems. Specifically, the present invention can be used to manufacture a high-quality optical system for little more than the cost of a comparable low-quality optical system.

The principles and operation of optical system manufacture according to the present invention may be better understood with reference to the drawings and the accompanying description.

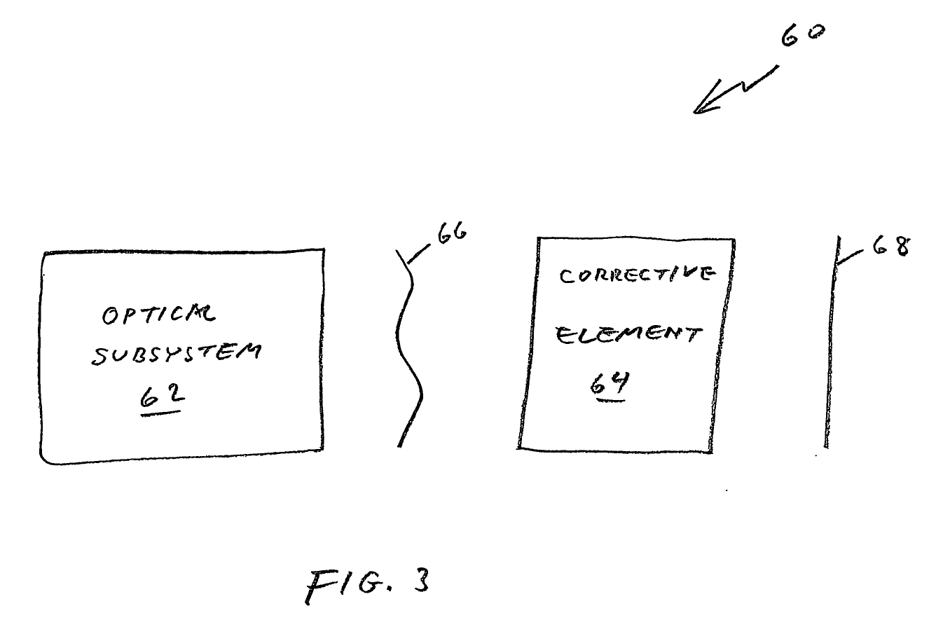

Returning now to the drawings, FIG. 3 is a schematic illustration of a basic optical system 60 of the present invention. The direction of light propagation in FIG. 3 is from left to right. Optical system 60 includes a conventional optical subsystem 62. Optical subsystem 62 could be a complete optical instrument, for example a telescope or a microscope, or a subsystem of a larger system, for example a camera lens, or even a single optical element such as a lens or a concave mirror. Optical system 60 also includes a static corrective optical element 64. Optical subsystem 62 is fabricated to a relatively low precision, for example half of the shortest wavelength that optical system 60 is intended to deal with. Static corrective optical element 64 is fabricated to a higher precision, for example one-tenth of the shortest wavelength that optical system 60 is intended to deal with. Because of the relatively low precision with which optical subsystem 62 is fabricated, optical subsystem 62 suffers from aberration, represented in FIG. 3 by an oscillating wavefront 66 emerging from optical subsystem 66. Static corrective optical element 64 is designed, as described below, to correct this aberration. Light emerging from static corrective element 64 is free of aberration, as represented in FIG. 3 by a flat wavefront 68.

Static corrective optical element 64 is represented in FIG. 3 as a transmissive optical element. It will be appreciated by those skilled in the art that static corrective optical element 64 alternatively could be a reflective optical element.

In what follows, the direction of light propagation is assumed to be parallel to the z-axis of a Cartesian (x,y,z) coordinate system. Quantitatively, the aberration represented by wavefront 66 is a phase deviation Δφ(x,y) from the design phase of coherent monochromatic light of wavelength λ. To design static corrective optical element 64, this phase deviation must be measured. Methods of measuring this phase deviation are well-known in the prior art. Among these methods are interferometry, as described in Optical Shop Testing (Daniel Malacara, editor) (John Wiley & Sons, 1978) (see especially page 76); and the use of a Shack-Hartman wavefront sensor, as described in the Malacara book and also by W. H. Southwell in “Wavefront estimation from wave-front slope measurements”, J. Opt. Soc. Am. vol. 70 pp. 998-1006 (1980).

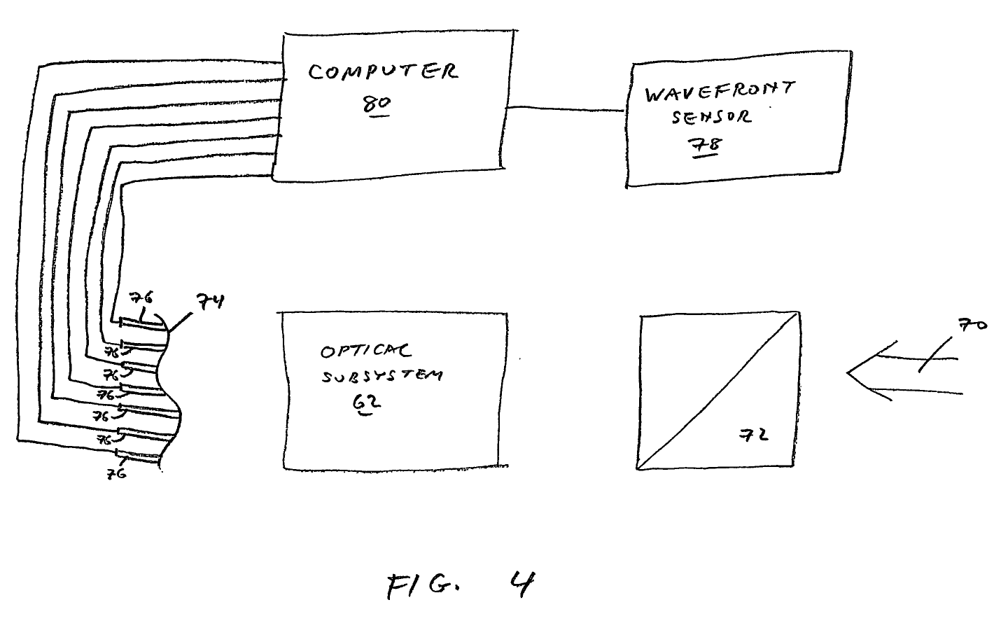

Another method of measuring the phase deviation is illustrated schematically in FIG. 4. A plane wave 70 of coherent monochromatic light of wavelength λ passes through optical subsystem 62 and is reflected by a deformable mirror 74 back through optical subsystem 62 to beamsplitter 72. At beamsplitter 72, a portion of the reflected light is reflected to a wavefront sensor 78 that detects the variation in phase across its sensing surface. This variation is transmitted to a computer 80 that uses a nonlinear optimization algorithm to determine the shape of mirror 74 that is needed to eliminate the phase variation detected by wavefront sensor 78. The shape of deformable mirror 74 is controlled by a two-dimensional array of actuators 76. (For illustrational simplicity, only one column of actuators 76 is shown in FIG. 4.) Computer 80 activates actuators 76 to change the is shape of deformable mirror 74 to the shape that computer 80 determined. Wavefront sensor 78 again measures the variation in phase across its sensing surface. If this variation in phase is less than a predetermined value, then the shape of deformable mirror 74, as determined by computer 80 from the settings of actuators 76, is a map of the phase deviation. Specifically, if Δz(x,y) is the departure of the shape of deformable mirror 74 from its average z-coordinate, then Δφ(x,y)=−4πΔz(x,y)/λ. If the variation in phase is not less than the predetermined value, then the nonlinear optimization and the measurement in phase variation are repeated until the measured phase variation is less than the predetermined value. Note that the nonlinear optimization algorithm must be robust enough to avoid getting trapped in a local minimum of its penalty function. Suitable algorithms for this purpose include simulated annealing algorithms and genetic algorithms. Simulated annealing algorithms are described in P. J. M. Van Laarhoven and E. H. L. Aarts, Simulated Annealing: Theory and Applications (Mathematics and its Applications 37), D. Reidel, 1987. Genetic algorithms are described in Michael D. Vose, The Simple Genetic Algorithm: Foundations and Theory, MIT Press, 1999.

One kind of static corrective optical element 64 that corrects for a given phase deviation Δφ(x,y) is a thin transparent plate, with an index of refraction n, flat to within the desired precision on one side and with the other side contoured with a profile

$${P}_{T} ( x , y ) = \frac{λ Δ ϕ ( x , y )}{2 ( n - 1 ) π} .$$

Such a static corrective optical element 64 is a transmissive optical element Another kind of static corrective optical element 64 that corrects for a given phase deviation Δφ(x,y) is a reflective optical element: a mirror with a profile P_{R}(x,y)=0.25λΔφ(x,y)/π.

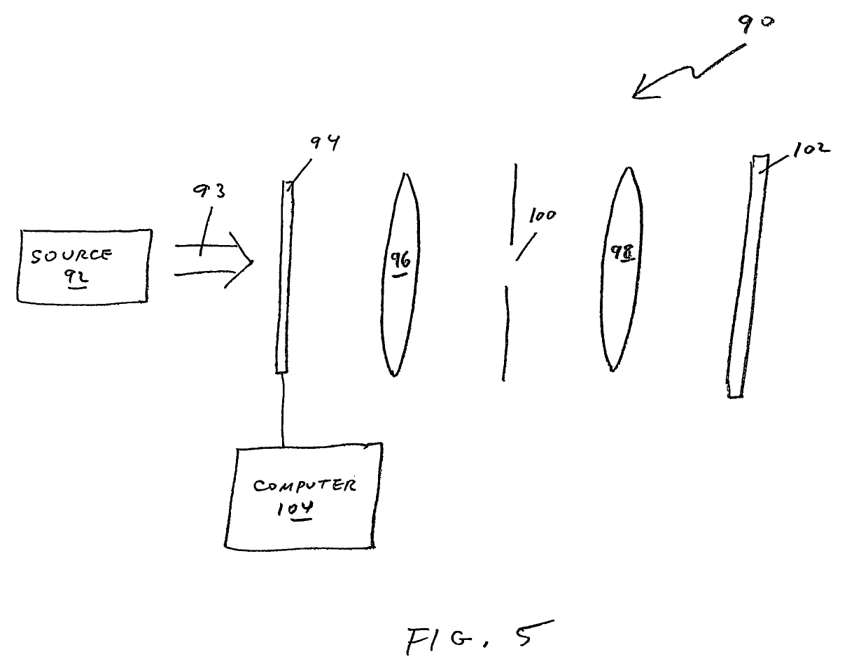

FIG. 5 is a schematic illustration of a photolithographic projective device 90 for making a transmissive static corrective optical element 64. The pixels of a liquid crystal spatial light modulator (SLM) 94 are provided with opacities proportional to P_{TMAX}−P_{T}(x,y), where

$${P}_{T MAX} = {max}_{x , y} {P}_{T} ( x , y ) ,$$

with pixels at coordinates (x,y) such that

$${P}_{T} ( x , y ) = {min}_{x , y} {P}_{T} ( x , y )$$

being totally opaque. A plane wave 93 from a source 92 is modulated by SLM 94 and then is projected onto a rigid sheet 102 of positive photoresist by a projection system that includes two Fourier transform lenses 96 and 98 separated by an aperture 100. Aperture 100 acts as a spatial filter to allow only the first order diffraction pattern of the modulated light from lens 96 to reach lens 98, in order to reduce the pixellation of the light that reaches sheet 102. Note that the wavelength of plane wave 93 generally is not the same as the wavelength of plane wave 70: plane wave 93 is supposed to induce a chemical change in sheet 102, whereas the optical element that sheet 102 eventually becomes is supposed to be insensitive to plane wave 70. For example, plane wave 70 may be visible or infrared light, and plane wave 93 may be ultraviolet light. After sheet 102 is exposed in this manner, sheet 102 is immersed in a developer. The depth to which material is dissolved by the developer from the surface of sheet 102 that was exposed to the light, as a function of lateral coordinates (x,y), is proportional to both the integrated flux of light to which sheet 102 was exposed at coordinates (x,y) and the amount of time that sheet 102 remains in the developer. The total development time is selected so that the final shape of the exposed side of sheet 102 is P_{T}(x,y).

The discussion above assumes that the depth to which the light from source 92 modifies the chemistry of the photoresist of sheet 102 is a linear function of the cumulative intensity of the light impinging on the photoresist. In some photoresists, this function is nonlinear. When such photoresists are used, the opacities of the pixels of SLM 94 are modified accordingly.

Alternatively, sheet 102 is made of a photoresist whose index of refraction is modified by exposure to the light from source 92. The required change in the index of refraction n is

$$Δ n ( x , y ) = \frac{λ Δ ϕ ( x , y )}{2 π L} ,$$

where L is the thickness of sheet 102.

As another alternative, static corrective optical element 64 is made by laser ablation of a rigid transparent sheet.

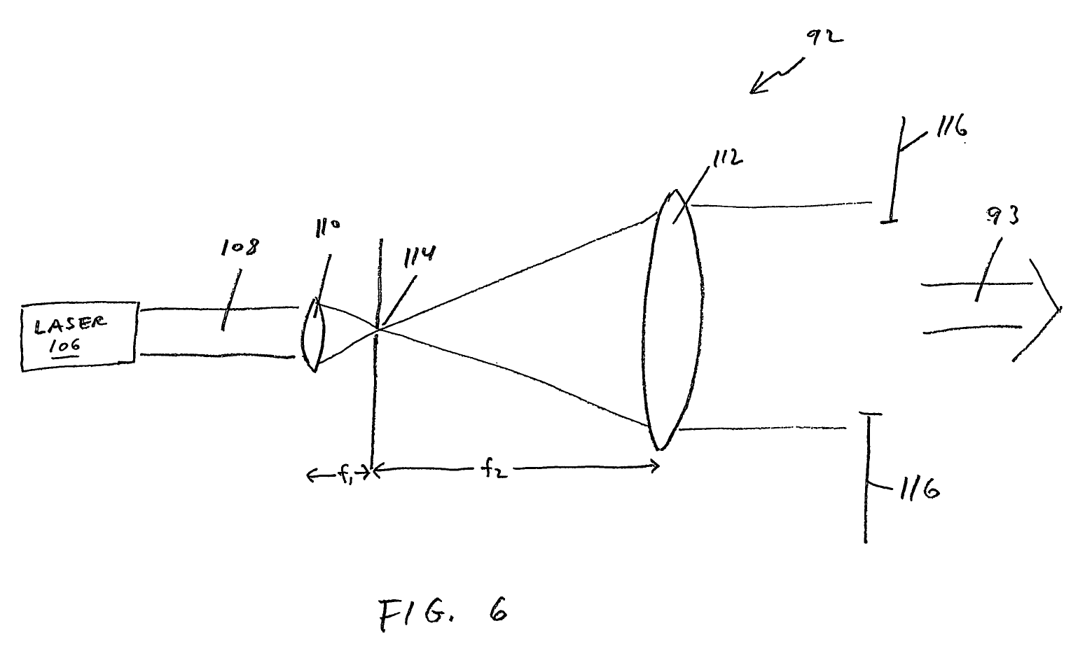

FIG. 6 is a schematic illustration of source 92. A laser 106, for example a HeNe laser or an Ar⁺ laser, emits a beam 108 of coherent monochromatic light of the desired wavelength. Beam 108 is collimated by two high-quality concave lenses 110 and 112 in a telescope configuration. Lens 110 has a focal length of f₁. Lens 112 has a focal length of f₂>f₁. Lenses 110 and 112 are a distance f₁+f₂ apart. Between lenses 110 and 112, at a distance f₁ from lens 110 and on the optical axis of the telescope, is a pinhole 114. The optimal diameter of pinhole 114 is a tradeoff between luminosity and planarity of plane wave 93, with a smaller pinhole 114 having lower luminosity but better planarity. The optimum diameter is about 10 microns. An iris 116 allows only the central portion of the light emerging from lens 112 to emerge from source 92 as plane wave 93. With the substitution of a suitable alternative laser for laser 106, FIG. 6 also serves to illustrate a source of plane wave 70.

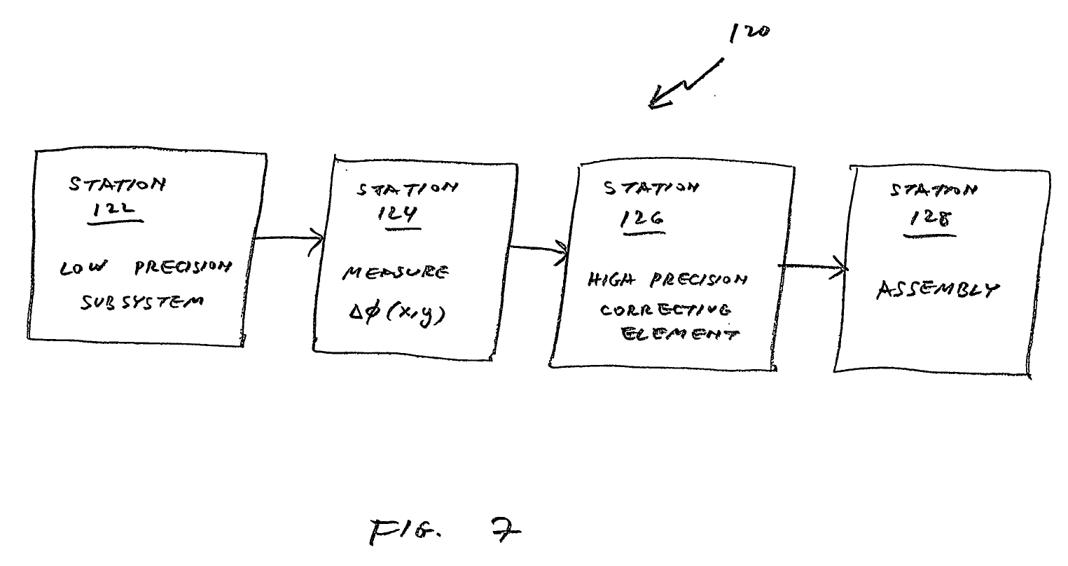

FIG. 7 is a schematic illustration of a production line of the present invention, for manufacturing optical systems 60. At a first station 122, optical subsystems 62 are fabricated to relatively low precision. At a second station 124, the phase deviation of each optical subsystem 62 is measured, for example by the method illustrated in FIG. 4. At a third station 126, the measurements from second station 124 are used as a basis for fabricating corresponding static corrective optical elements 64. Third station 126 could include, for example, photolithographic projective device 90. At a fourth station 126, optical systems 60 are assembled, with static corrective optical elements 64 fixed in place relative to the corresponding optical subsystems 62 so as to correct the aberrations of optical subsystems 62 to high precision so that the overall performance of optical systems 60 is that that would have been obtained in the absence of static corrective optical elements 64 if optical subsystems 62 had been fabricated to high precision.

While the invention has been described with respect to a limited number of embodiments, it will be appreciated that many variations, modifications and other applications of the invention may be made.

What is claimed is:

1. A method of making an optical system, comprising the steps of:
(a) fabricating an optical subsystem of the optical system to within a first precision;
(b) measuring an aberration of said optical subsystem to within a second precision that is more precise than said first precision; and
(c) fabricating a static optical element that corrects said aberration to within said second precision.

2. The method of claim 1, wherein said measuring is effected using interferometry.

3. The method of claim 1, wherein said measuring is effected using a Shack-Hartman wavefront sensor.

4. The method of claim 1, wherein said measuring is effected by steps including:
(i) providing a deformable mirror including a plurality of actuators, each said actuator for positioning a respective portion of a surface of said deformable mirror;
(ii) passing a light wave that is initially a plane wave through said optical subsystem;
(iii) after said light wave passes through said optical subsystem, reflecting said light wave from said deformable mirror;
(iv) measuring a property of said reflected light wave that is related to said aberration; and
(v) adjusting said actuators until said measuring of said property indicates that said deformable mirror corrects said aberration to within said second precision.

5. The method of claim 4, wherein said property is a wavefront shape of said reflected light wave, and wherein said adjusting is effected until said measured wavefront is planar to within said second precision.

6. The method of claim 4, wherein said adjusting is effected using a nonlinear optimization algorithm.

7. The method of claim 6, wherein said optimization algorithm is a simulated annealing algorithm.

8. The method of claim 6, wherein said optimization algorithm is a genetic algorithm.

9. The method of claim 4, wherein said reflected light wave again passes through said optical subsystem prior to said measuring of said wavefront shape.

10. The method of claim 1, wherein said fabricating of said static optical element is effected by steps including configuring a shape of said static optical element to correct said aberration.

11. The method of claim 1, wherein said fabricating of said static optical element is effected by steps including configuring an index of refraction of said static optical element to correct said aberration.

12. The method of claim 1, wherein said fabricating of said static optical element is effected by photolithography.

13. The method of claim 1, wherein said fabrication of said static optical element is effected by laser ablation.

14. The method of claim 1, wherein said static optical element is a transmissive optical element.

15. The method of claim 1, wherein said static optical element is a reflective optical element.

16. The method of claim 1, further comprising the step of:
(d) fixing said static optical element relative to said optical subsystem so as to correct said aberration.

17. An optical system comprising:
(a) an optical subsystem fabricated to within a first precision; and
(b) a static optical element, fabricated to within a second precision that is more precise than said first precision, for correcting an aberration of said optical subsystem.

18. A device for making an optical element, comprising:
(a) a source for emitting a light wave that is a plane wave;
(b) a spatial light modulator for modulating said plane wave in accordance with a predetermined profile, thereby transforming said plane wave into a modulated light wave; and
(c) a projection system for projecting said modulated light wave onto a photosensitive workpiece, as one step in transforming said workpiece into the optical element.

19. The device of claim 18, wherein said spatial light modulator is a liquid crystal spatial light modulator.

20. The device of claim 18, wherein said projection system includes:
(i) a first lens;
(ii) a second lens; and
(iii) an aperture, between said first lens and said second lens, for allowing only a first order diffraction pattern of said modulated light wave to pass from said first lens to said second lens.

21. The device of claim 20, wherein said lenses are Fourier transform lenses.

22. The device of claim 18, wherein said workpiece includes photoresist.

23. A method of making an optical element that is configured with a predetermined profile, comprising the steps of:
(a) modulating a light wave that is a plane wave in accordance with the profile, thereby transforming said plane wave into a modulated light wave; and
(b) projecting said modulated light wave onto a photosensitive medium so as to prepare said photosensitive medium for transformation to the optical element.

24. The method of claim 23, further comprising the step of:
(c) developing said photosensitive medium for an amount of time sufficient to configure said photosensitive medium with the profile, thereby transforming said photosensitive medium into the optical element.

25. The method of claim 23, wherein said photosensitive medium includes photoresist.

26. A production line for making a plurality of optical systems for manipulating light to within a desired precision, comprising:
(a) a first station for fabricating, for each optical system, a respective optical subsystem to within a preliminary precision that is less precise than the desired precision;
(b) a second station for measuring a respective aberration of each said optical subsystem to within the desired precision; and
(c) a third station for fabricating, for each optical system, a respective static optical element that corrects said respective aberration to within the desired precision.

27. The production line of claim 26, further comprising:
(d) a fourth station for fixing each said static element relative to said respective optical subsystem so as to correct said respective aberration.
